(19) United States
(12) Patent Application Publication
(10) Pub. No.: US 2012/0280021 A1
(43) Pub. Date: Nov. 8, 2012

(54) METHOD FOR PRODUCING AN INTEGRALLY BLADED ROTOR USING ARCUATE FRICTION WELDING, DEVICE FOR CARRYING OUT SAID METHOD, AND ROTOR PRODUCED BY MEANS OF SAID METHOD

(75) Inventors: Frank Stiehler, Bad Liebenwerda (DE); Hans Peter Borufka, Starnberg (DE); Patrick Prokopczuk, Munchen (DE)

(73) Assignee: MTU AERO ENGINES GMBH, Munchen (DE)

(21) Appl. No.: 13/508,862

(22) PCT Filed: Nov. 12, 2010
(86) PCT No.: PCT/DE2010/001335

§ 371 Date: May 9, 2012

(30) Foreign Application Priority Data
Nov. 13, 2009 (DE) 10 2009 052 880.6

(51) Int. Cl. B23K 20/12

(52) U.S. Cl. 228/114.5; 228/2.3

(57) ABSTRACT

A method for producing an integrally bladed rotor, in particular a gas turbine rotor, comprises the following steps:—Providing a blade (12) having a lower blade foot that has a joining surface (18);—Retaining the blade (12) in a retaining unit (20); and—Exciting the blade (12) to oscillate about an axis of rotation. A device for carrying out the method comprises a retaining unit, in which blade (12) can be solidly clamped in place, and an oscillating unit (24) that transmits translational oscillations to the retaining unit in a plane substantially parallel to joining surface (18), and a fixation unit (30) for establishing the axis of rotation.

The invention relates to a method for producing an integrally bladed rotor, in particular a gas turbine rotor. The invention further relates to a device for carrying out the method. The invention also relates to a rotor produced by means of the method.

Gas turbine rotors having integral blading are named blisk or bling depending on whether the rotor or rotor support (called a basic rotor body in the following) that is present is shaped like a disk or a ring in cross section. Blisk is the abbreviated form of “bladed disk” and bling of “bladed ring”.

It is known from the prior art to produce gas turbine rotors having integral blading by milling from solids. Since this method is very complicated and expensive, it is utilized only for producing relatively small gas turbine rotors.

For larger rotors, joining methods are used in which basic rotor body and blades are produced separately and subsequently are joined together. Of the joining methods, linear friction welding (LFW) has gained great importance in the last few years. Here, one of the parts to be joined is firmly clamped in place, while the other oscillates with a linear motion. By pressing the parts together, frictional heat arises. The material in the region of the welding zone is heated to forging temperature. The parts are upset, so that a weld bead is formed in the joining region, after which the bead is removed by adaptive milling.

EP 0 624 420 B1 relates to a rotational friction welding method with a special angular-motion friction welding device that makes possible the simultaneous welding of several blades to a basic rotor body. A first retaining unit for a part moves the basic rotor body around its axis of rotation and this is executed without axial or other motion components. The blades are held by additional retaining units and clamped against the periphery of the oscillating, rotating basic rotor body. For the actual welding process, the movement of the basic rotor body is stopped. A disadvantage here is the great effort that must be expended for the rapid change in direction during rotation of the heavy basic rotor body.

A method for blading a rotationally symmetrical blade support for turbo machines by means of friction welding is known from EP 0 513 669 A2, in which an uptake mechanism with two clamping jaws that can be clamped against one another are used for fixing a blade in place. By tightening screws, the clamping surfaces of the clamping jaws clamp between them the blade foot on rectangular side surfaces. The welding temperature necessary for joining the body is achieved by a linear oscillation of the welding surface of the blade opposite the welding surface of the blade support. Although this motion is designated “translational oscillation”, it actually involves a purely linear movement without pivoting (rotational motion) the blade or the welding surface thereof.

The problem of the invention is to make possible a problem-free joining of closely adjacent blades on a basic rotor body during the production of an integrally bladed rotor.

The method according to the invention for producing an integrally bladed rotor, in particular a gas turbine rotor, by means of joining comprises the following steps:

Providing a blade having a lower blade foot that has a joining surface;

Retaining the blade in a retaining unit; and

Exciting the blade to oscillate about an axis of rotation.

The method step “Exciting the blade to oscillate” according to the invention shall comprise both a forced oscillation by repeated introduction of forces onto a blade region outside the axis of rotation and alternatively a (non-permanent) excitation of the blade to intrinsic oscillations about the axis of rotation.

In comparison to the known method according to EP 0 624 420 B1, the basic rotor body is not moved, but rather the blades are moved. Here, the method according to the invention makes it possible to directly join closely adjacent blades to a basic rotor body by means of friction welding, due to the oscillations about an axis of rotation that preferably lies outside (above or below) the blade foot, since the blades do not move significantly in the region of the axis of rotation. A displacement of the outer shroud and any striking against adjacent blades are avoided thereby. It is thus not necessary to maintain gaps between the blades or to enlarge them and to close these gaps subsequently by means of additional devices. Rather, conventional shroud designs (including z- and double-z-notch) can be kept, which has a favorable effect on manufacturing costs.

The device according to the invention for carrying out the method comprises a retaining unit, in which the blade can be firmly clamped in place, and an oscillating unit, which transmits translational oscillations to the retaining unit in a plane substantially parallel to the joining surface, as well as a fixation unit for establishing the axis of rotation.

Finally, the invention also creates an integrally bladed rotor, in particular for gas turbines, which is produced according to the method according to the invention.

Advantageous and appropriate configurations of the invention are given in the subclaims.

Additional features and advantages of the invention result from the following description and from the appended drawings, to which reference is made. In the drawings:

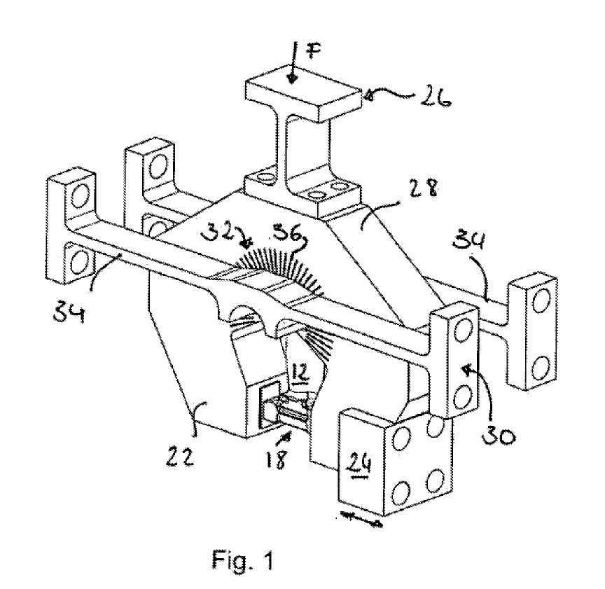

FIG. 1 shows a perspective front view of a device according to the invention, with blade clamped in place, with which integrally bladed rotors are produced according to the method according to the invention; and

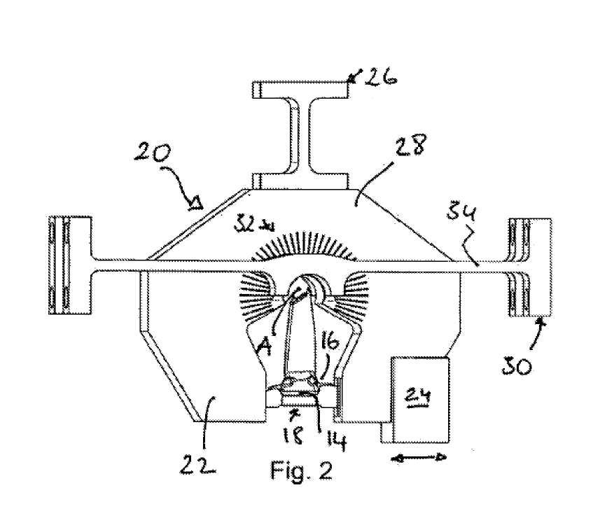

FIG. 2 shows a perspective rear view of the device.

A device for producing an integrally bladed rotor by means of joining is shown in FIGS. 1 and 2. The device can be used, in particular, in the scope of a friction welding process, which will be discussed later.

The integrally bladed rotor that can be used in the compressor or turbine region of a gas turbine has a basic rotor body (not shown) in the form of a disk or a ring. Blades 12 that can be formed of monocrystalline material are fastened to the basic rotor body that can be formed of polycrystalline material.

A blade 12 extends from a blade foot 14, by which blade 12 is fastened to the basic rotor body, up to a tip of the blade surface. An inner shroud 16 or an outer shroud (optionally) are integrally disposed on blade foot 14 and on the tip of the blade surface, respectively. The region below the inner shroud 16 is preferably not coated. On the side opposite the blade tip, blade foot 14 has a joining surface 18 that comes in contact with a corresponding joining surface of the basic rotor body during the joining process. Joining surface 18 is either planar or slightly curved, which will be discussed later.

The device comprises a retaining unit 20, in which blade 12 is solidly clamped in place. In this case, retaining unit 20 engages on a suitable uncoated region of blade foot 14 underneath inner shroud 16 in the vicinity of joining surface 18. A modified clamping in place is also possible for totally uncoated blades. The upper blade region including the outer shroud—as long as it is present—is either free or clamped in place so that it is movable to a certain extent with utilization of the elasticity of the blade. In the example of embodiment shown, the retaining unit 20 is configured U-shaped, blade 12 being clamped in place between two retaining legs 22.

An oscillating unit 24 (indicated only schematically) engages at least on one of retaining legs 22, this unit transmitting linearly the translational oscillations at approximately the level of joining surface 18 to retaining unit 20, in a plane essentially parallel to joining surface 18. Joining surface 18 can also be curved, in particular, when larger oscillation amplitudes are provided. In this case, the curvature of joining surface 18 is preferably coordinated with the oscillating movement, i.e., the curvature has a radius that corresponds to the distance of joining surface 18 from the axis of rotation A.

Further, an upsetting unit 26 (indicated schematically) is provided, with which an upsetting force F perpendicular to joining surface 18 of blade 12 can be introduced on blade 12 in the direction of the basic rotor body. In the example of embodiment shown, upsetting unit 26 engages on section 28 of retaining unit 20 joining the two retaining legs 22.

Retaining unit 20, oscillating unit 24 and/or upsetting unit 26 can be assembled with additional components into a friction welding system.

The device finally comprises another fixation unit 30, which is coupled, on one side, to retaining unit 20 via at least one solid joint 32, and on the other side, is rigidly coupled to a component that is immovable at least relative to retaining unit 20 and oscillating unit 26, e.g., a housing of the friction welding system.

In the example of embodiment shown, fixation unit 30 has two fixation legs 34, the first ends of which are fixed to the immovable component as described, while the second ends merge into solid joint 32 in section 28 of retaining unit 20.

Solid joint 32 defines an axis of rotation A, which runs above blade foot 14, preferably in the region of the outer shroud (as long as it is present) or in the vicinity of the blade tip or over this, in the example of embodiment shown. A special feature of the construction of the device can be seen from the fact that solid joint 32 is open and thereby permits a positioning of blade 12 to be joined such that the axis of rotation A runs through blade 12. Ideally, axis A runs through the contact surfaces in the outer shroud. The axis of rotation A is oriented essentially parallel to joining surface 18. Basically, however, a construction is also possible, in which the axis of rotation A lies underneath blade foot 14.

A solid joint is characterized in general by one or more places with reduced flexural rigidity and is thereby bounded by adjacent rigid regions. Solid joints can lead to movements that are free of play and without friction and function without further maintenance or lubrication.

In the example of embodiment shown, the locally reduced flexural rigidity is achieved by means of perforations 36 in the form of slits. Perforations 36 are disposed around the connection sites to which fixation legs 34 are connected to section 28 of retaining unit 20. The regions between perforations 36 function as soft-bending rods. The axis of rotation A can be influenced as desired by suitable selection of the arrangement and dimensions of perforations 36 as well as the position of the connection sites.

In order to weld blades 12 clamped in place in retaining unit 20 to the basic rotor body lying underneath the blades, i.e., opposite the joining surface, the basic rotor body is firmly retained, and oscillating unit 24 introduces an oscillating movement with very low amplitude (approximately 2 mm) on retaining unit 20. Based on the special positioning of retaining unit 20 above fixation unit 30, retaining unit 20 executes oscillations about the axis of rotation A with blades 12 that are firmly clamped in place. Based on the position of the axis of rotation A in the upper region or above blade 12, the upper region of blade 12 including the outer shroud (as long as it is present) moves little or not at all in this case, as long as the axis of rotation A does not lie very far above blade 12.

Upsetting unit 26 presses oscillating blade 12 perpendicularly to joining surface 18 onto an opposite-lying joining surface of the basic rotor body. In this way, material is expelled in the oscillating direction due to the friction oscillations until, after having achieved a specific upsetting path, the oscillations are stopped.

1. A method for producing an integrally bladed rotor by means of joining, comprising the steps of:
providing a blade (12) having a lower blade foot (14) that has a joining surface (18);
retaining the blade (12) in a retaining unit (20); and
exciting the blade (12) to oscillate about an axis of rotation (A); joining surface (18) of blade foot (14) being matched to a joining surface of a basic rotor body to which blade (12) will be joined, both joining surfaces having a curvature with a radius that substantially corresponds to the distance of the joining surfaces from the axis of rotation A.

2. The method according to claim 1, wherein the axis of rotation (A) lies outside, preferably above blade foot (14).

3. The method according to claim 1, further characterized in that wherein the axis of rotation (A) runs through contact surfaces in an outer shroud of blade (12).

4. The method according to claim 1, wherein the axis of rotation (A) runs parallel to joining surface (18).

5. (canceled)

6. The method according to claim 1, wherein blades (12) are excited to oscillate by transmitting translational oscillations in a plane substantially parallel to joining surface (18).

7. A device, comprising:
a retaining unit (20), in which blade (12) can be clamped firmly in place;
an oscillating unit (24) that transmits translational oscillations to retaining unit (20) in a plane substantially parallel to joining surface (18); and
a fixation unit (30) for establishing the axis of rotation (A) the fixation unit (30) having at least one solid joint (32), by means of which the axis of rotation (A) is specified.

8. The device according to claim 7, wherein the retaining unit (20) is engaged with a region of blade foot (14) underneath an inner shroud (16) in the vicinity of joining surface (18), whereas the region of blade (12) lying over this is not clamped in place.

9. The device according to claim 7, wherein the retaining unit (20) is configured U-shaped and blade (12) can be clamped in place between two retaining legs (22).

10. The device according to claim 9, wherein an upsetting unit (26) engages on a section (28) of retaining unit (20) connecting the two retaining legs (22), and introduces an upsetting force F perpendicular to joining surface (18).

11. (canceled)

12. The device according to claim 7, wherein the solid joint (32) is open and thereby permits a positioning of the blade (12) to be joined such that the axis of rotation (A) runs through blade (12).

13. The device according to claim 7, wherein on one side, the fixation unit (30) is coupled to retaining unit (20) via a solid joint (32), and on the other side, is rigidly coupled to a component that is immovable relative to the retaining unit (20) and the oscillating unit 24.

14. The device according to claim 13, wherein the fixation unit (30) has fixation legs (34), the first ends of which are coupled to the immovable component, while the second ends are connected to retaining unit (20) via solid joints (32).

15. The device according to claim 1, further characterized in that the one or more solid joints (32) is/are formed by perforations (36) that locally reduce the flexural rigidity of retaining unit (20).

16. (canceled)
